(19) United States
(12) Patent Application Publication
(10) Pub. No.: US 2011/0143328 A1
(43) Pub. Date: Jun. 16, 2011

(54) Method and Apparatus for Enhancing an Academic Environment

(76) Inventor: Gerald Alfred Brusher, Novi, MI (US)

(21) Appl. No.: 12/636,902

(22) Filed: Dec. 14, 2009

(51) Int. Cl. G09B 7/00

(52) U.S. Cl. 434/362

(57) ABSTRACT

A method for guiding a problem solver includes determining one or more fundamental skills necessary to solve a problem. The method also includes associating the one or more fundamental skills with the problem in an electronic format. The method further includes selecting one or more portions of media corresponding to the one or more fundamental skills and presenting a user with an electronic display of at least one of the one or more portions of media corresponding to the one or more fundamental skills associated with the problem.

### BACKGROUND AND SUMMARY OF ILLUSTRATIVE EMBODIMENTS

In many learning environments, skills taught in classes build on skills gained in previous classes. For example, solving problems in calculus often require a background in algebra. In a more complex example, solving a problem in

Often, teachers will have to guide students to use the skills learned in previous classes. For example, a teacher giving a lecture in calculus may reference algebra skills learned in previous studies. Such guidance may be useful in a classroom environment, but when a teacher is not available, such as when a student is doing homework at home, another source of reference to previously learned skills may be needed.

Teachers preparing a curriculum may also wish to ensure that the curriculum includes certain skill sets that reference or improve on skills gained in earlier studies or determined to be useful in future studies. As curriculums become increasingly complex in more advanced studies, it may be possible that replacing one lecture with another causes a skill set to be overlooked or accidentally removed from a curriculum.

Similarly, certain skill sets may be deemed necessary for a complete course in a particular field of study. These could be self-set standards or based on a predetermined set of skills. Since a variety of topics may be covered in a given course, a teacher may wish to ensure that all of the “necessary” skills are being covered within the topics.

To perform all of these activities, reference to previous books, lesson plans and or preset curriculum standards may be used. This cross referencing, however, may be complex and it is easy to overlook an essential element. Further, especially in the case of a student attempting to solve a new problem in an unfamiliar field, it may not even be possible since the student may not remember which skills are used. Or the student may search down numerous futile or incorrect paths before coming to the eventual proper source for finding the fundamentals to solve a problem.

Current course management tools include Blackboard, MOODEL and WEBCT, but these tools may not be sufficient for the needs of some educators and students.

In one illustrative embodiment, a method for guiding a problem solver (such as, but not limited to, a student solving a problem or coordinating research, etc.) includes determining one or more fundamental skills necessary to solve a problem and associating the one or more fundamental skills with the problem in an electronic format. The method also includes selecting one or more portions of media corresponding to the one or more fundamental skills. The method also includes presenting a user with an electronic display of at least one of the one or more portions of media corresponding to the one or more fundamental skills associated with the problem.

In a second illustrative embodiment a method of preparing a curriculum includes determining a plurality of fundamental skills desired to be referenced during topics covered in a curriculum. This exemplary method also includes electronically associating one or more of the fundamental skills with each of one or more the topics.

In this illustrative embodiment, the method further includes selecting a plurality of the fundamental skills for inclusion in a curriculum and selecting a plurality of the topics for inclusion in the curriculum. This exemplary method also includes electronically referencing the fundamental skills associated with a plurality of the topics selected for inclusion in the curriculum.

The exemplary method further includes electronically comparing the referenced fundamental skills with the plurality of fundamental skills selected for inclusion in the curriculum to determine which fundamental skills have been included and/or which fundamental skills have not been included with the curriculum based at least in part on the topics which were selected. Finally, the method includes providing a user with an electronic display showing at least one of which fundamental skills were determined to be included or which of the fundamental skills were determined not to have been included with the curriculum based at least in part on the topics which were selected.

In still a third illustrative embodiment a method of preparing a curriculum includes determining a plurality of fundamental skills desired to be referenced during topics covered in a curriculum. This exemplary method also includes electronically associating one or more of the fundamental skills with each of one or more the topics and selecting a plurality of the fundamental skills for inclusion in a curriculum.

Further, this exemplary method includes electronically referencing the topics associated with a plurality of the fundamental skills selected for inclusion in the curriculum to determine which topics correspond to the selected fundamental skills Finally, this method includes providing a user with an electronic display showing a list of the electronically referenced topics associated with the fundamental skills.

### BRIEF DESCRIPTION OF THE DRAWINGS

FIG. 1 shows an exemplary set of different concepts from a course and associated metadata.

FIG. 2 shows an illustrative example of multiple disciplines sharing the same fundamental concept values;

FIG. 3 shows an illustrative example of a series of linked problems, fundamental skills and media references;

FIG. 4 shows an illustrative embodiment of a second relationship according to the invention;

FIG. 5 shows an exemplary illustrative method of providing guidance to a problem solver;

FIG. 6 shows another illustrative embodiment using associations between fundamental skills and topics;

FIG. 7 shows an alternative illustrative embodiment using associations between fundamental skills and topics; and

FIG. 8 shows an illustrative example of a program display.

### DETAILED DESCRIPTION OF THE PREFERRED EMBODIMENT(S)

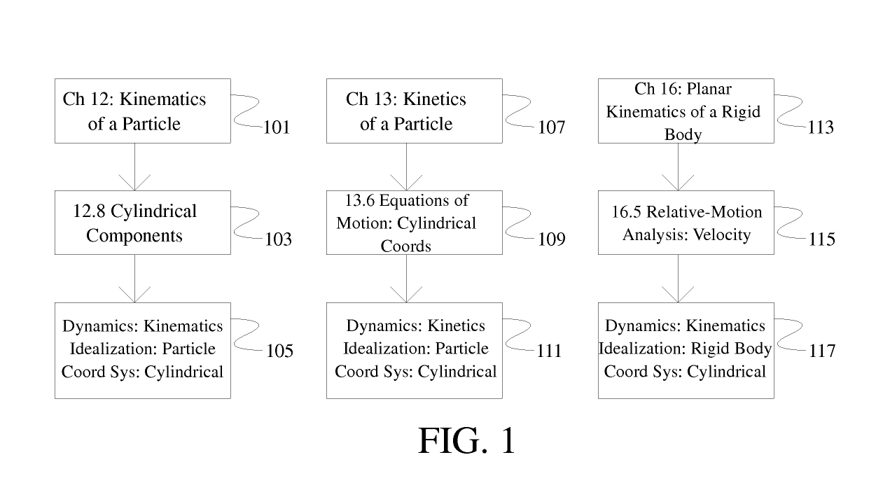

FIG. 1 shows an exemplary set of different concepts from a course and associated metadata. In this illustrative embodiment, metadata is used to refer to fundamental concepts electronically associated with particular concepts.

For example, Chapter 12 101, teaches about the Kinematics of a Particle. Chapter 12 section 8 103 discusses Cylindrical Components. This subsection has three concepts 105 associated with it in this embodiment, Dynamics, Idealization, and Coordinate System. Further, each of the concepts has a particular value associated therewith, Kinematics, Particle, Cylindrical, respectively.

In this illustrative embodiment, the concepts and values are consistent and fundamentally based on an agreed upon structure. Put another way, they're not ad hoc based on a folksonomy developed by a particular teacher. This allows them to be universally distributed and understood.

Of course, in another illustrative embodiment, folksonomic concepts and values could be used, if so desired by a user or instructor.

Chapter 13 107 discusses Kinetics of a Particle, and section 6 109 of this chapter discusses Equations of Motion: Cylindrical Coordinates. This section also has the same three concepts 111 associated therewith. In this example, the values associated with the concepts are the same except the Dynamics value is Kinetics.

Chapter 16 113 discusses Planar Kinematics of a Rigid Body, and section 5 115 discusses Relative-Motion Analysis: Velocity. Again, the concepts 117 Dynamics, Idealization and Coordinate System are associated with this section, providing a universal cross referencing system, at least within the book itself, in this embodiment. But, in this case, the Idealization value is Rigid Body, not Particle.

If a student were attempting to solve a problem dealing with cylindrical coordinates, that student might first be presented with all three of these sections as possible sources of useful information.

The sources could then be narrowed further by noting that the idealization of the problem to be solved is particle. This would limit the range of options to 12.8 103 and 13.6 109.

Finally, the student may note that the problem is a Kinematics problem, and the student would be directed to chapter 12, section 6 for resources. These particular fields could also be directly associated with the problem so that, for example, if a student clicked on an electronic version of a particular problem, an exemplary look-up system could reference the values associated with that problem and find the corresponding chapter.

As noted, in this illustrative embodiment, the concepts and values have consistent names throughout. This allows dynamic addition and subtraction of material to an electronic text. If chapter 12 were removed, the problem might not have anything to refer back to, until new material was inserted, but if new material having the corresponding concept values were inserted anywhere in the electronic text, the exemplary look-up system could easily find that material.

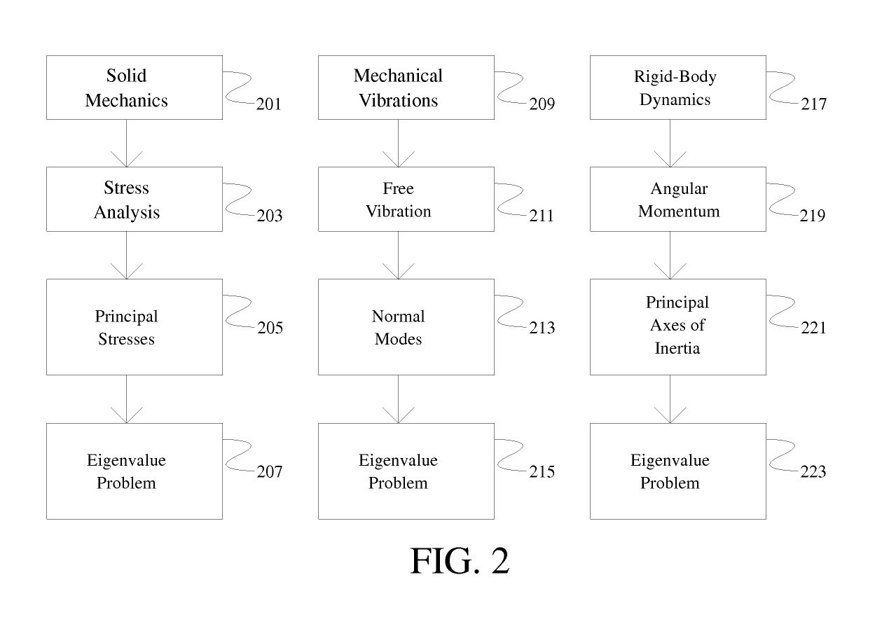

FIG. 2 shows an illustrative example of multiple disciplines sharing the same fundamental concept values. In this illustrative example, a student studying solid mechanics 201 could be learning about stress analysis 203, specifically, principle stresses 205. This is an eigenvalue 207 problem, and problems in this subsection could have a concept field with the value eigenvalue associated therewith.

Similarly, students studying mechanical vibrations 209 and rigid body dynamics 217 could be focused on free vibration 211 and angular momentum 213 respectively. Within those studies, the students could respectively be examining normal modes 213 and principal axes of inertia 221, which are both eigenvalue 215, 223 problems.

It may be the case that none of the references used for these courses, however, covers solving eigenvalue problems, because it may be assumed that such a skill was previously learned.

However, if a universal taxonomy is used by, for example, a publisher or group of publishers, or even by a professor preparing a series of courses, then a student can be referred back to a section from a previously taken class to understand the fundamentals of solving eigenvalue problems.

Even with a folksonomy (i.e., a self-defined taxomony developed by a professor or group of professors in accord, but one which may not conform to conventional standards) such cross reference can be made, as long as concepts and values thereof are kept consistent throughout the localized courses.

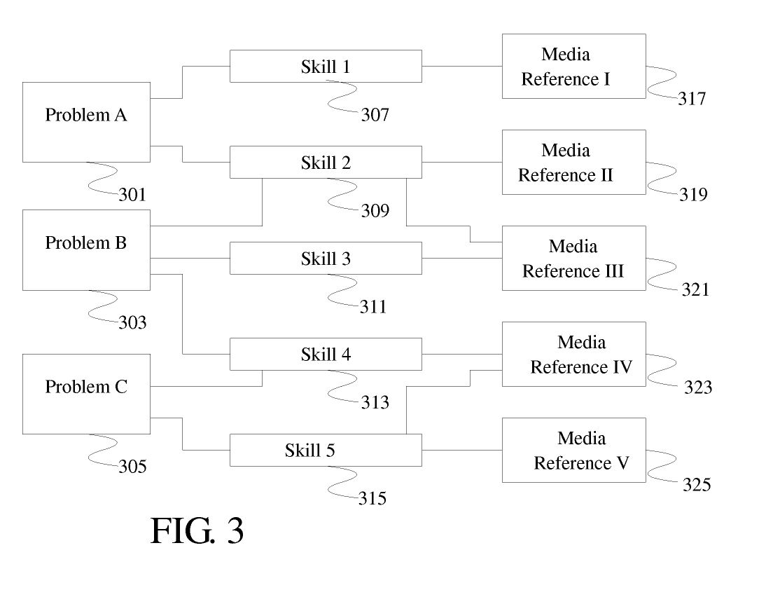

FIG. 3 shows an illustrative example of a series of linked problems, fundamental skills and media references.

In this illustrative example, Problems A 301, B 303 and C 305 are independent homework problems each requiring a different set of fundamental skills to solve. The invention, however, is not limited to the solving of homework problems.

Problem A 301, is linked in some manner to fundamental skills 1 307 and 2 309. In one illustrative embodiment, the linking is done through a relational database. For example, Problems A, B and C can each have an entry in a relational database. Then, for example, there may be a field in the database called “fundamental skills” (any suitable name for the field will suffice). In this illustrative embodiment, Problem A has fundamental skills Skill 1 307 and Skill 2 309 associated with it. Problem B has fundamental skills Skill 2 309, Skill 3 311 and Skill 4 313 associated with it. Problem C has fundamental skills Skill 4 313 and Skill 5 315 associated with it.

In this illustrative embodiment, each skill has a media reference associated with it (more than one media reference could be associated with a skill). For example, without limitation Media References I, III and IV could be book from an earlier classes teaching the fundamental skills they're associated with. Media Reference II could be a website teaching a skill, and Media Reference V could be an electronic book.

A person attempting to solve Problem A can use the database (or other electronic linking) to look up what fundamental skills are required to solve the problem. Further, the links to the media references can also provide a quick and easy reference for the problem solver to send that person directly to proper section of the reference.

Such a relational database or other electronic linking could be integrated into a computer program for use with one or more problem sets to be solved. Teachers could create the relationships dynamically, or the publisher of a book having problems could distribute the book with the problems being pre-linked to fundamental skills and referring back to media made by that publisher or other publishers.

For example, a CD/DVD (or other storage media) could be provided with a book and contain the problems, the linkages and any other necessary information. Students could use this CD when working on the problems so that they can be properly referred to the fundamental skills they should be using to solve the problem.

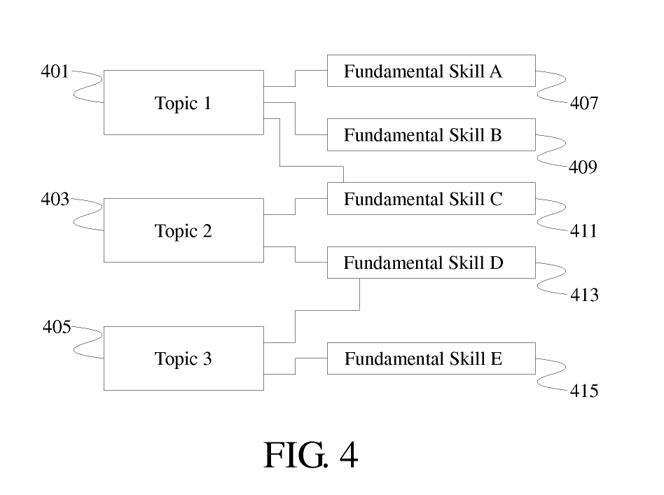

FIG. 4 shows an illustrative embodiment of a second relationship according to the invention. In this illustrative embodiment, the teacher has a certain number of fundamental skills that the teacher wishes to cover in a lecture. For example, in this illustrative embodiment, Topic 1 401 covers Fundamental Skills A 407, B 409 and C 411. Topic 2 403 covers Fundamental Skills C 411 and D 413, and Topic 3 405 covers Fundamental Skills D 413 and E 415. If the teacher is trying to plan a curriculum, the teacher can determine which fundamental skills are to be covered in the curriculum. Then, based on which topics cover those skills, the curriculum can be planned.

In this illustrative embodiment, if the teacher wishes to include all five fundamental skills in the lecture series, the teacher can select Topics 1 and 3 for inclusion. If the teacher only wanted to cover skills C and D, then Topic 2 could be used. This database or other electronic relationship between fundamental skills and topics for lecture inclusion can be used to plan a course for a semester. Using a basic cross-referencing function a teacher can select a plurality of fundamental skills to be covered in the semester. Using this list of fundamental skills, the database (or other system) can find the most efficient list of topics that will also teach all of these skills.

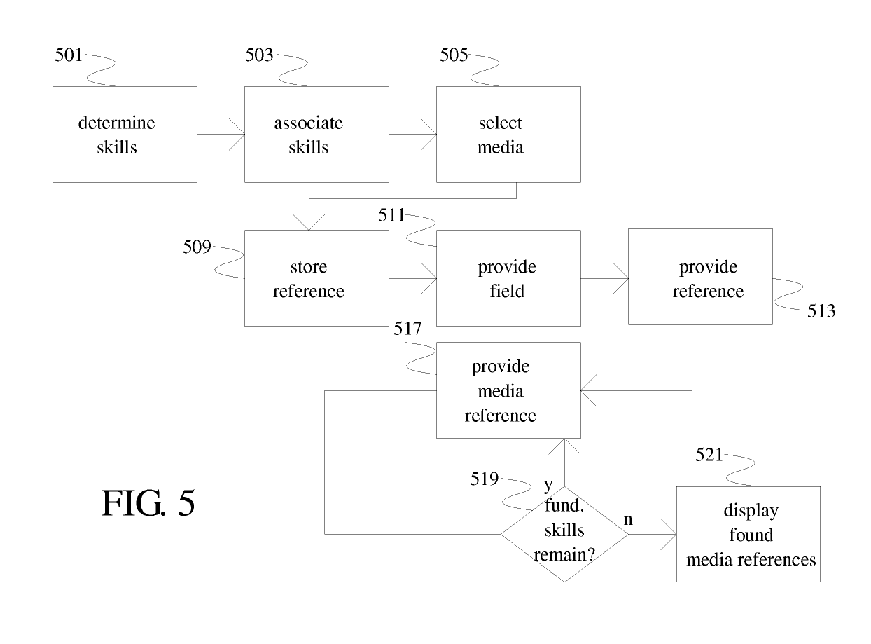

FIG. 5 shows an exemplary illustrative method of providing guidance to a problem solver using relationships between the problem, fundamental skills and one or more pieces of media. In this illustrative embodiment, a series of fundamental skills are first determined 501. These skills can be determined at the publisher or they can be determined by a lecturer or other party after distribution of the problems.

Next, one or more problems each have one or more of the fundamental skills associated with them 503. As previously noted, this can be done using an electronic database or other electronic system. Each skill is also associated with one or more pieces of media that is selected 505 as teaching that fundamental skill. The media can be electronic, paper form, etc.

References to each problem are stored in a relational database 509, allowing lookup of the various problems and the fundamental skills and media associated therewith. A field is also provided in the relational database in which fundamental skills can be stored 511. In this illustrative embodiment, each problem has one or more of the fundamental skills associated with it.

Further, in the database, one or more references are associated with each of the fundamental skills 513. These references can be used to refresh a problem solver's memory. When a problem is searched for in the relational database the problem is found by reference stored in the database. Then, in this illustrative embodiment, a fundamental skill field is referenced. The fundamental skill field, in this illustrative embodiment, stores the fundamental skills determined to be useful in solving the problem. Each fundamental skill has one or more media references associated therewith, and at least one media reference is provided to a user 517 for one or more of the fundamental skills associated with the problem. The system then determines if any fundamental skills still associated with the problem remain, and for each remaining skill, in this illustrative embodiment, one or more references are provided to a user.

Additionally, it may be possible to electronically display any number of the references provided. If the references are to a website, an electronic text, an electronically stored reference (such as a pdf), etc., on or more of the references may actually be displayed to the user upon completion 521 (or at any other appropriate point in the cycle). This illustrative embodiment is exemplary only, and is not meant to limit the various ways in which this process can be implemented using an electronic storage system, such as, but not limited to, a relational database.

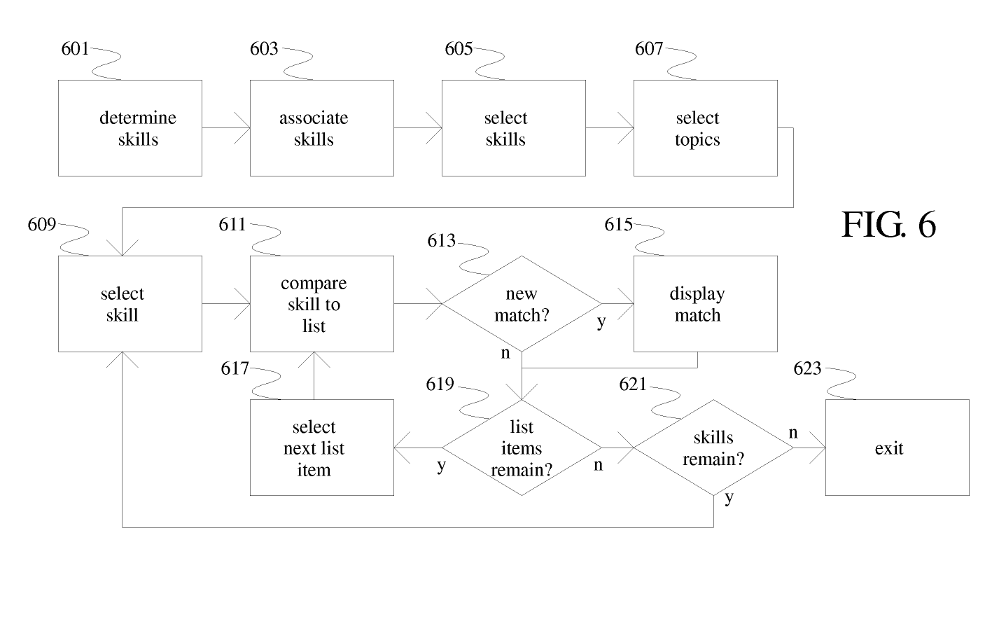

FIG. 6 shows another illustrative embodiment. In this illustrative process, a teacher, for example, can use the association between fundamental skills and topics to plan a curriculum. By using the relationship between skills and topics, a teacher can ensure that all necessary fundamental skills are covered by the topics presented in a curriculum.

In one illustrative embodiment, a set of fundamental skills is determined 601. This can be determined by, for example, without limitation, by a teacher preparing a curriculum, or by a publisher or by a board of teachers, etc. Each of the skills is then associated with one or more topics 603. A given topic may cover more than one skill. The association can be done, for example, without limitation, using a relational database.

Next, the curriculum planner can select some or all of the skills that are desired to be covered in a given course 605. These can be dynamically selected each semester or whenever the curriculum planner decides that a new set of skills should be taught. Then a curriculum planner can select the topics desired to be covered in a course 607. This can be based on, for example, past topics covered, etc.

Each topic has one or more skills associated with it in, for example, an electronic medium, such as a relational database. A first skill from the skills associated with the topics is selected 609. That skill is compared 611 to the list of skills selected in step 605. For each comparison, the process determines if there is a match 613 between the skill associated with the topic selected in step 609 and one of the fundamental skills for the curriculum on the list selected in step 605. If there is a match, the system displays the match 615, letting the curriculum planner know which skills from the fundamental skills list are covered by that topic. In this manner, the planner can accurately determine that all desired fundamental skills are covered by the topics selected to be taught. If, at the end of topic selection, certain fundamental skills are not covered, the planner can select additional or alternative topics to ensure all fundamental skills are covered.

Once the match has been displayed (or if there is no match), the system then determines if there are additional fundamental skills to which a comparison is to be made 619. If so, the next item on the list of fundamental skills is selected 617 and another comparison is made 611.

If no fundamental skills from the fundamental skill list remain for selection, then the system determines if there are skills remaining that are associated with the selected topics for which a comparison has not yet been made 621. If no skills remain, then the system exits, else the next fundamental skill associated with a topic is then selected and compared to the desired fundamental skills in the manner described above.

This illustrative embodiment is but one exemplary process by which topic and skill selection can be made. Numerous steps and can be rearranged and added or removed if needed to achieve the desired results within the scope and spirit of the invention.

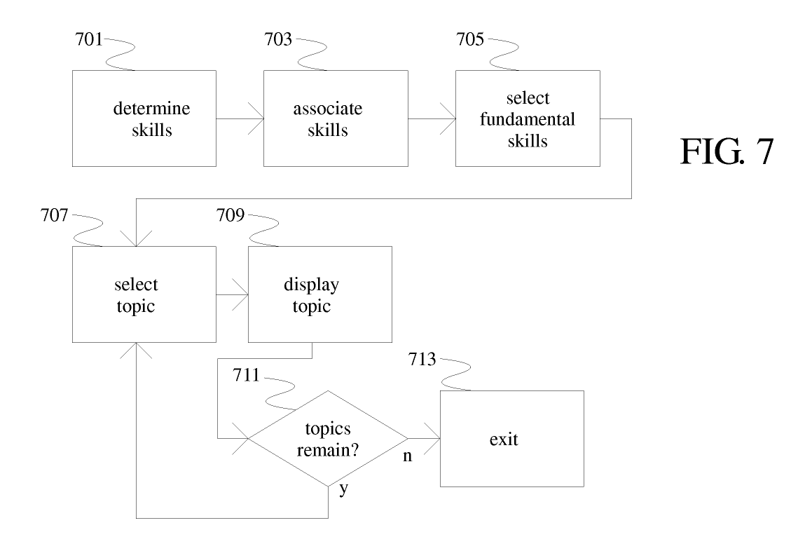

FIG. 7 shows an alternative method for selecting topics and fundamental skills for a curriculum, also meant as an exemplary non-limiting embodiment. In this illustrative example, a set of fundamental skills for possible inclusion in a curriculum is determined 701. This could be done, for example, by a curriculum planner, by a publisher, by a standards board, etc. These skills are then each associated electronically (using, for example, without limitation, a relational database) with one or more topics to potentially be covered in a curriculum 703. A curriculum planner then selects one or more fundamental skills to be covered in a curriculum 705. For example, an entire set of fundamental skills that are desired for coverage are selected by the planner. As previously noted, each skill has one or more topics associated therewith in an electronic format. From this association, a topic is selected 707.

The selected topic is then display, for example, on an electronic display for user review 709. The system then checks to see if any topics that have not yet been displayed remain that are also associated with the selected fundamental skills 711. If topics remain, the process of 707, 709, 711 is repeated, else the system exits. Using this exemplary embodiment, once an initial association between topics and fundamental skills has been made, a planner and simply select whatever fundamental skills are desired to be taught, and see a list of all topics that will provide coverage of those fundamental skills.

As with the previous illustrative embodiments, this process is merely exemplary and is not intended to limit the invention in any way. Efficiency algorithms, for example, can be applied to determine the shortest subset of all topics that will also cover all the desired fundamental skills. Or the algorithms can be set to provide a fixed number of topics covering the fundamental skills (corresponding, for example, to a number of classes in a curriculum).

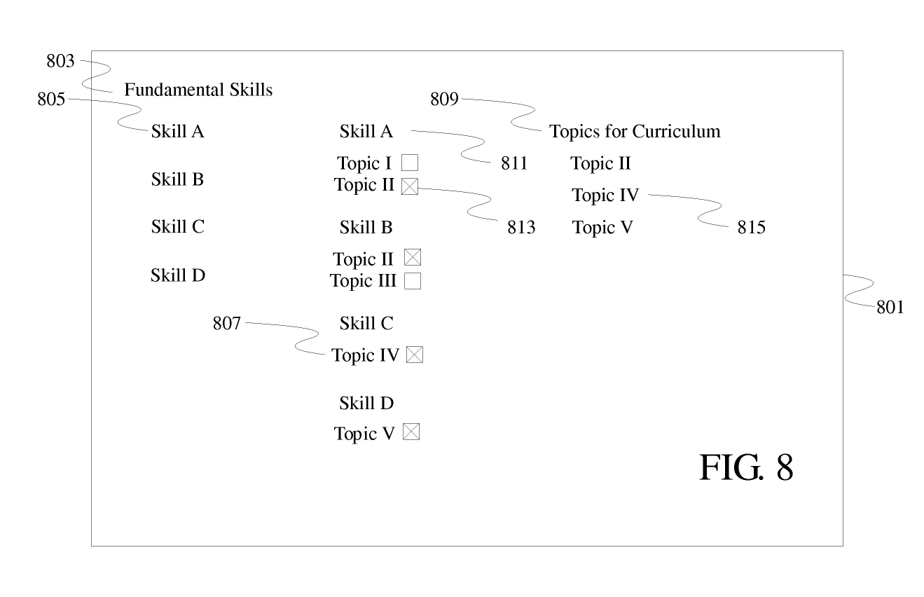

FIG. 8 shows an illustrative example of a program display 801 that enacts some or all of the illustrative embodiments encompassed by the descriptions herein. In this illustrative example, a list of selected fundamental skills 803 is shown. These skills 805, are, for example, selected on a previous screen, or comprise a list of skills determined to be necessary for a course. For example, when a new textbook is selected for a class, each topic of the book can have a set of skills associated with it. This information can be loaded into a usable database for access by this exemplary program.

Next a list of each skill is shown 811 and under the skills, each topic related to that skill is shown 813. This allows a curriculum planner to determine which topics are available that correspond to the needed skills. The user can then select the various topics for inclusion. Selecting, for example, topic II under skill A, will cause topic II to also be selected under skill B (thus allowing the planner to see that skill B is also now covered).

On the right side of the screen in this illustrative example, the topics to be covered in the curriculum are also displayed 809. As topics 813 are selected, these topics 815 appear in this list, providing a concise list of the topics to be covered in the course.

This is just one exemplary display that can be provided in conjunction with the illustrative embodiments to facilitate the processes described herein. Suitable different displays may also be utilized.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A method for guiding a problem solver comprising:
determining one or more fundamental skills necessary to solve a problem;
associating the one or more fundamental skills with the problem in an electronic format;
selecting one or more portions of media corresponding to the one or more fundamental skills;
presenting a user with an electronic display of at least one of the one or more portions of media corresponding to the one or more fundamental skills associated with the problem.

2. The method of claim 1, wherein the media is a textbook.

3. The method of claim 1, wherein the media is an electronic book.

4. The method of claim 1, wherein the associating electronically further comprises:
storing a reference to the problem in a relational database;
providing one or more fields related to the fundamental skills;
providing a reference to one or more of the fundamental skills in a corresponding provided field.

5. The method of claim 4, further comprising:
storing a reference to at least one of the one or more portions of media in the relational database;
determining the at least one portion of media associated with a corresponding fundamental skills through a database look-up based at least in part on at least one of the fundamental skills provided in the corresponding provided field.

6. The method of claim 1, further comprising:
presenting the user with a link to at least one of the portions of media, wherein the portion of media is an electronic source.

7. The method of claim 1, further comprising: providing the user with a name of a source containing at least one of the one or more portions of media.

8. The method of claim 7, further comprising:
providing the user with a chapter number or name containing at least one of the one or more portions of media.

9. The method of claim 1, further comprising:
providing the user with an example showing one or more of the fundamental skills.

10. The method of claim 9, wherein the example is taken from the one or more portions of media associated with the corresponding fundamental skill.

11. A method of preparing a curriculum comprising:
determining a plurality of fundamental skills desired to be referenced during topics covered in a curriculum;
electronically associating one or more of the fundamental skills with each of one or more the topics;
selecting a plurality of the fundamental skills for inclusion in a curriculum;
selecting a plurality of the topics for inclusion in the curriculum;
electronically referencing the fundamental skills associated with a plurality of the topics selected for inclusion in the curriculum;
electronically comparing the referenced fundamental skills with the plurality of fundamental skills selected for inclusion in the curriculum to determine which fundamental skills have been included and/or which fundamental skills have not been included with the curriculum based at least in part on the topics which were selected; and
providing a user with an electronic display showing at least one of which fundamental skills were determined to be included or which of the fundamental skills were determined not to have been included with the curriculum based at least in part on the topics which were selected.

12. The method of claim 11, wherein the electronically associating and the electronically referencing are further performed using a relational database.

13. The method of claim 12, further comprising:
providing at least one field associated with one or more of the one or more topics, wherein the field is operable to store at least one of the fundamental skills associated with a given topic.

14. A method of preparing a curriculum comprising:
determining a plurality of fundamental skills desired to be referenced during topics covered in a curriculum;
electronically associating one or more of the fundamental skills with each of one or more the topics;
selecting a plurality of the fundamental skills for inclusion in a curriculum;
electronically referencing the topics associated with a plurality of the fundamental skills selected for inclusion in the curriculum to determine which topics correspond to the selected fundamental skills; and
providing a user with an electronic display showing a list of the electronically referenced topics associated with the fundamental skills.

15. The method of claim 14, wherein the electronically associating and the electronically referencing are further performed using a relational database.

16. The method of claim 15, further comprising:
providing at least one field associated with one or more of the one or more fundamental skills, wherein the field is operable to store at least one of the topics associated with a given fundamental skill.

17. The method of claim 14, further including providing an electronically selectable list of the displayed electronically referenced topics.

18. The method of claim 17, further including:
providing an electronic display of a plurality of topics, wherein the topics were selected from the electronically selectable list by the user.
